(19) United States
(12) Patent Application Publication
(10) Pub. No.: US 2003/0033851 A1
(43) Pub. Date: Feb. 20, 2003

(54) Method and apparatus for detection of illegal substances in commerce

(76) Inventors: Daniel E. Gelfman, Miami, FL (US); Olaf Teder, Miami, FL (US)

Correspondence Address: BARBARA S. KITCHELL, Akerman, Senterfitt & Eidson, P.A., 222 Lakeview Avenue, Suite 400, West Palm Beach, FL, 33401, US

(21) Appl. No.: 09/927,895

(22) Filed: Aug. 10, 2001

(51) Int. Cl. G01N 7/00

(52) U.S. Cl. 73/19.01; 73/23.2

(57) ABSTRACT

The present invention provides methods and related systems for efficiently detecting substances that are illegally transported in commerce, particularly by common carriers. The methods rely on a vacuum-induced collection of particulates from bulk material used to subvert or deter conventional detection methods. The disclosed methods are particularly adaptable for detecting illegal drugs such as cocaine but are also applicable to explosives and toxic materials. The methods may be employed for inspecting cargo shipments as well as smaller packages such as luggage and airline carry-on items.

### BACKGROUND OF THE INVENTION

1. Field of the Invention

The invention is concerned with methods and devices for facilitating the detection of controlled substances such as drugs, narcotics and explosives in commercial shipments and illegally transported personal effects. The disclosed methods are particularly useful for detecting the presence of illegal drugs and explosives in containerized and packaged goods transported by commercial carriers.

2. Description of Related Art

Drug interdiction agencies such as the United States Customs Service and Drug Enforcement Agency (DEA) are responsible for monitoring contraband substances hidden in commercial cargo, aircraft, sea vessels, trucks, as well as in passenger baggage and carry-on articles, aircraft and equipment. US Customs and other agencies currently rely on manual searches, x-ray screening and other imaging technology to detect illegal materials. These procedures are time-consuming and labor intensive. In the case of cargo shipments, the screening equipment is expensive and requires a large capital investment. Where individuals are involved, delays may interfere with personal freedom or business schedules.

Imported goods and goods transiting U.S. ports, airports and road gateways pose a particular challenge because a balance must be maintained between effective screening of cargo and minimal interference with commercial movement of cargo. Highly perishable cargo such as flowers, fruits, vegetables and fish must be rapidly screened in order to preserve quality and marketability.

Until recently, imaging systems for screening bulk cargos were considered to be reasonably effective. Aircraft pallets, unit load devices (ULD), containers and crates could be screened by x-ray or other imaging techniques. The detection is conventionally performed with x-ray or MRI systems. A disadvantage is that the apparatus is expensive and bulky and can be defeated by sophisticated smugglers.

Analysis devices have been developed that rely on wiping or sweeping the periphery of packages and personal carry-on of airline passengers; however, such analysis is extremely labor intensive and relies on detecting external residues.

A major concern, due to the increasingly sophisticated masking techniques employed by smugglers, is the potential failure of the currently employed screening methods to detect illegally imported goods, particularly illegal drugs, The detection methods themselves are sufficiently sensitive and still are relatively effective for detecting contraband incorporated into legal materials or wrapped in special packaging materials. However, smugglers have discovered means to interfere with the measurements such as by shipping wet cargo; for example, by immersing goods such as fish or flowers in water causing interference with imaging methods such as magnetic resonance imaging (MRI).

In some cases, inspectors have employed analytical techniques that rely on increasing the vapor pressure of sample residues by heating the sample in special devices. Samples can also bee collected by wiping surfaces or on filters. Unfortunately, illegal substances can be masked to evade detection.

Accordingly, there exists a need for methods of detecting selected substances that are illegally imported or transported in interstate commerce. Current analytical methods are sufficiently sensitive to identify most substances but are subject to interference by blocking agents. There is therefore an ongoing need for efficient and effective real-time methods for detecting illegal substances.

### SUMMARY OF THE INVENTION

The disclosed methods and apparatus address some of the deficiencies in currently used methods of screening goods for illegal substances. The disclosed methods are particularly effective in identifying drugs that are hidden in large commercial shipments, without the need to disturb the packaging materials. Air cargo pallets, for example, can be analyzed quickly and close to the unloading point. Importantly, the method reliably detects small amounts of illicit material, even when contraband is co-mingled in bulk with other materials or is part of wet cargo.

The methods employ an apparatus that creates a low-pressure environment by reducing the atmospheric pressure within the cargo being examined. The vacuum causes traces of drugs or contraband to vaporize and/or particles to become displaced from within the package or cargo container being examined without disturbing the bulk product or packaging. The particles or vapor-containing molecules of illicit material are drawn into a sampling chamber, withdrawn and analyzed by any of a number of well-known sensitive means that will distinguish the signature of the substance of interest. The flow rate and sample volume may be modulated to conform to the operating characteristics of the analytical device being employed.

The free flow path of vapors and particles may be increased and gas density decreased in direct proportion to pressure reduction inside the vacuum chamber by continuously running a vacuum pump(s). The flow of air being exhausted from the sampling chamber in the suction side piping is concentrated into a piping manifold where vaporized particulates from the sample are removed upstream of the pump. An analytical device may be attached to the sampling chamber to detect vaporized traces of contraband substances.

The vapor release rate in the vacuum chamber is determined by the temperature and vapor saturation pressure at a selected pressure level. The vaporization and molecular flow rate may be rapidly accelerated by reducing the pressure to the vapor saturation pressure; however, the temperature may be so reduced that vaporization becomes much less effective. A factor in efficiency and effective detection will be the rate at which the pressure is lowered to a value that provides enough particulates for analysis. Thus a high capacity vacuum system should be selected to optimize sampling time.

The new vacuum-based substance vaporization method may be employed for detection of many chemicals and is particularly useful for detecting contraband substances, including drugs and explosives. Of particular interest are cocaine, heroin and marijuana, all of which are regularly brought illegally into the United States from South America, Asia and other foreign origins. While the vapor pressures at which each drug may be effectively detected will vary, the principle is the same. Appropriate reduced pressure conditions for the selected material may be determined without undue experimentation, taking into account that temperature and pressure will be interrelated factors. The amount of vaporized sample provided to the detector will increase exponentially with drop in atmospheric pressure. The process of lowering atmospheric pressure surrounding the contraband material will thus make detection easier; however, if the temperature inside the closed container drops below a certain value, the beneficial effect of the lower pressure may be lost for certain compounds and thus should be determined on a case by case basis. In optional embodiments of the invention, a heating unit may be incorporated into the vacuum chamber.

In most applications, it is desirable to create a vacuum within the closed container containing the contraband substance over a relatively short period of time, preferably less than 20 minutes. Of course high volume vacuum pumps are capable of reducing pressure in limited airtight spaces within a few minutes. A relatively short time to reduce pressure prevents undue cooling and, importantly, allows relatively rapid real-time analysis. In preferred embodiments, the pressure is held at a constant level for a number of minutes before withdrawing a sample.

An important aspect of the invention is a method for detecting selected substances in bulk cargo. The bulk cargo may be virtually any type of cargo typically carried in aircraft, by rail, in trucks, by ships or in personal vehicles. Of particular interest are cargoes in which illegal drugs may be hidden so as to avoid visual and analytical detection. Living plants, fresh flowers, fruits and vegetables are often used as carriers for illegal drugs hidden by incorporating into the packing material or as imitation plant or flower parts. Bulk cargo shipments can be loaded into an enclosed environment; for example, an airtight room or pressure vessel. Because the environment is airtight, atmospheric pressure can be reduced by connecting a pipe or hose from the closed container to a suitable vacuum pump.

The vacuum pump operates to reduce the pressure within the closed space containing the bulk cargo. Depending on the substance to be detected, the pressure is reduced to a level that will induce vaporization of the drug or illegal substance suspected of being present. The pressure can be determined empirically or by referring to scientific data tables. In any event, at some reduced pressure level the selected substance, if present, will vaporize and particulates will be drawn from the bulk cargo. The vaporized particulates can then be sampled upstream from the vacuum pipe.

Samples are preferably collected on sampling media. As used herein, sampling media are any substances or materials that will collect the vaporized sample from the vacuum chamber effluent. Examples include cellulose strips, metal films, physical trapping devices, adsorbants and the like.

In some aspects of the invention, one may employ a system that includes an “add-on” apparatus to collect samples for analysis by a detection instrument, such as chromatography or spectrometer devices or particle or vapor analyzer. The “add-on” apparatus allows diverting of vaporized particulates from the vacuum chamber to the analytical instrument. The apparatus may be optionally equipped to control the quantity and velocity of air being directed to the analytical instrument from the sample collecting chamber.

In certain embodiments, the methods may be employed for detection of explosives. An extremely powerful explosive used by the military is cyclotrimethylenetrinitramine, commonly known as RDX, cyclonite or hexogen. This explosive is often mixed with plasticizing waxes and other explosives in varying percentages to form castable mixtures. RDX is one the most powerful and brisant of military high explosives. Other explosives are formulated as binary castable mixtures of RDX, TNT, powdered aluminum, wax and calcium chloride and is a combination of choice for use in missile warheads. These combinations are commonly referred to as HBX. One of the most powerful explosives is pentaerythirtoltetranitrate, also known as PETN. Cyclotol is another explosive used in shaped charge bombs.

### BRIEF DESCRIPTION OF THE DRAWINGS

FIG. 1 is a generalized diagram of the apparatus employed to vaporize selected materials within a vacuum chamber and to collect the vaporized samples for detection.

FIG. 2 illustrates the control system employed to maintain a constant pressure level for a selected time period.

FIG. 3 shows a threaded cap setup that provides a plurality of sampling probes.

### DETAILED DESCRIPTION OF THE PREFERRED EMBODIMENTS

The free flow path of vapors and molecules is increased and gas density decreased in direct proportion to pressure reduction in the vacuum chamber by continuously running a vacuum pump. This flow is picked up by the suction side piping of a vacuum pump and concentrated into a piping manifold where designated particles are sampled upstream of the pump.

The vapor release rate in the vacuum chamber is determined by temperature and vapor saturation at a given pressure. The vapor and molecular flow rate may be rapidly accelerated by adjusting the vacuum pump down system sized to achieve a fast product sample time.

The invention may now be described in more detail by reference to the figures.

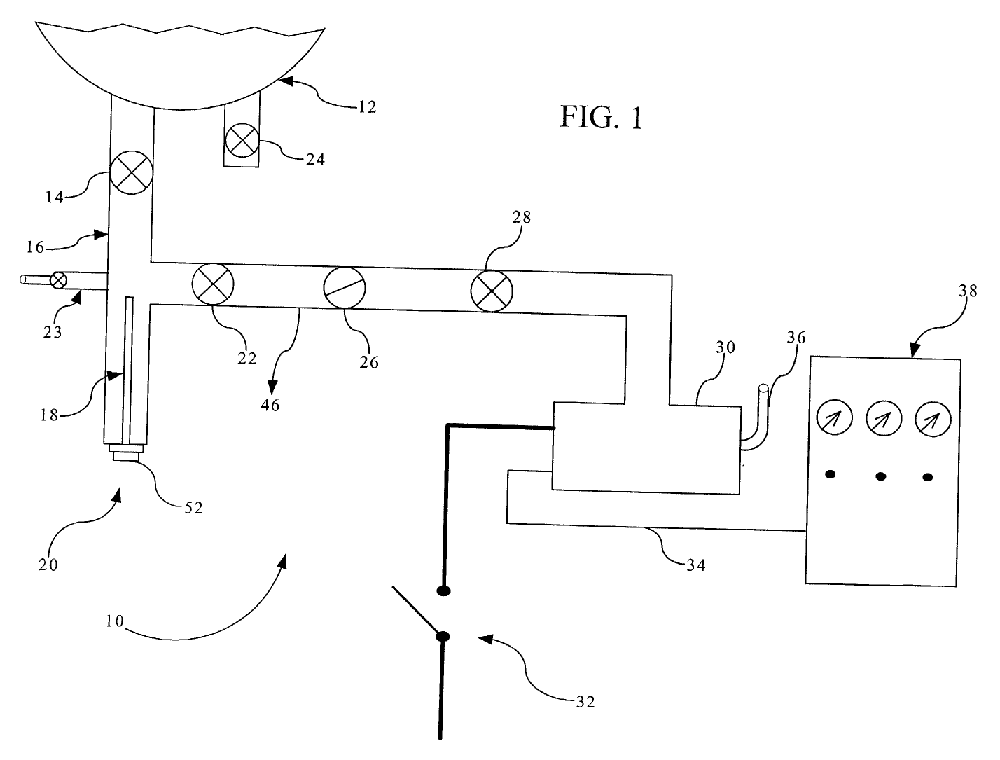

The invention can be practiced with a system substantially as shown in FIG. 1. The material to be tested is loaded into the vacuum chamber (12). A vacuum chamber pressure door is securely closed and the vacuum breaker valve (24) handle on the vacuum chamber (12) is moved into the closed position. A removable threaded cap (20), to which at least one sampling probe (18) is attached, is rotated open and removed from the sampling chamber (16). A sampling media (not shown) is attached to the sampling probe (18) and re-inserted into the sampling chamber (16). The removable threaded cap (20) is rotated closed to a tight fit to provide for an airtight seal.

The isolation valve (14) and isolation valve (22) are then opened along with the vacuum control valve (28). The operator then verifies that the power supply switch (32) to the vacuum pump (30) is in the closed position. The vacuum pump (30) is started via the control (34) for the console (38).

Proper operation of the vacuum pump (30) may be initially confirmed by observing discharge flow from the exhaust gas piping (36). With the pump-down process operation started, evacuation is confirmed by the movement of a pressure gauge (38) from 0-30 inches mercury.

A confirming pressure gauge (not shown) will indicate a reduction of pressure from atmospheric pressure down to near 0 mm Hg. More precise determination of the pressure may be measured with a third vacuum gauge sensitive in the range of 200 mm to 0 mm Hg.

The operation of the vacuum pump (30) causes a negative pressure resulting in a vapor flow from the vacuum chamber (12) through the suction piping (46). As this flow travels to the vacuum pump (30) it passes through the sampling chamber (16). The sampling media mounted inside the sampling chamber (16) collects a representative sample from the vapor flow.

As pressure is reduced in the vacuum chamber (12), vapor pressure approaches the flashpoint (boiling point of water at the respective level of vacuum.) Just before this point is reached, the pressure inside the vacuum chamber (12) is maintained at a constant level while the regulated vacuum pump (30) continues to operate. The continuous operation of the vacuum pump (30) permits sample data to be collected for analysis.

After the final sample has been taken, the vacuum pump (30) is stopped. The vacuum control valve (28) is closed. The isolation valve (14) and isolation valve (22) are closed. The vacuum breaker valve (24) is opened for re-pressurization. When the vacuum chamber (12) returns to atmospheric pressure the removable threaded cap (20) is removed. The sampling media is taken off the sampling probe (18) and inserted into an analytical instrument. A vacuum release valve (23) may be used for release of vacuum.

Time required for tests to be performed depends upon the volume of the vacuum chamber (12) and capacity of the vacuum pump (30). The system (10) can be calibrated to analytically detect and compensate for residues remaining from previous tests.

For example, a typical pump-down curve is shown in TABLE 1 for a high capacity pump connected to a cylinder having a volume of approximately 7,400 cubic feet.

TABLE 1
Pumpdown for system using four 15 hp vacuum pumps
equipped with 4 hp blowers

| Time (minutes) | Pressure (mm Hg) |
|---|---|
| 0 | 760.00 |
| 1.50 | 598.86 |
| 3.00 | 470.40 |
| 4.50 | 368.03 |
| 6.00 | 286.45 |
| 7.50 | 221.42 |
| 9.00 | 169.59 |
| 10.50 | 128.27 |
| 12.00 | 95.30 |
| 13.50 | 68.67 |
| 15.00 | 47.59 |
| 16.50 | 31.23 |
| 18.00 | 18.23 |
| 19.50 | 9.02 |
| 21.00 | 4.24 |
| 21.38 | 3.50 |

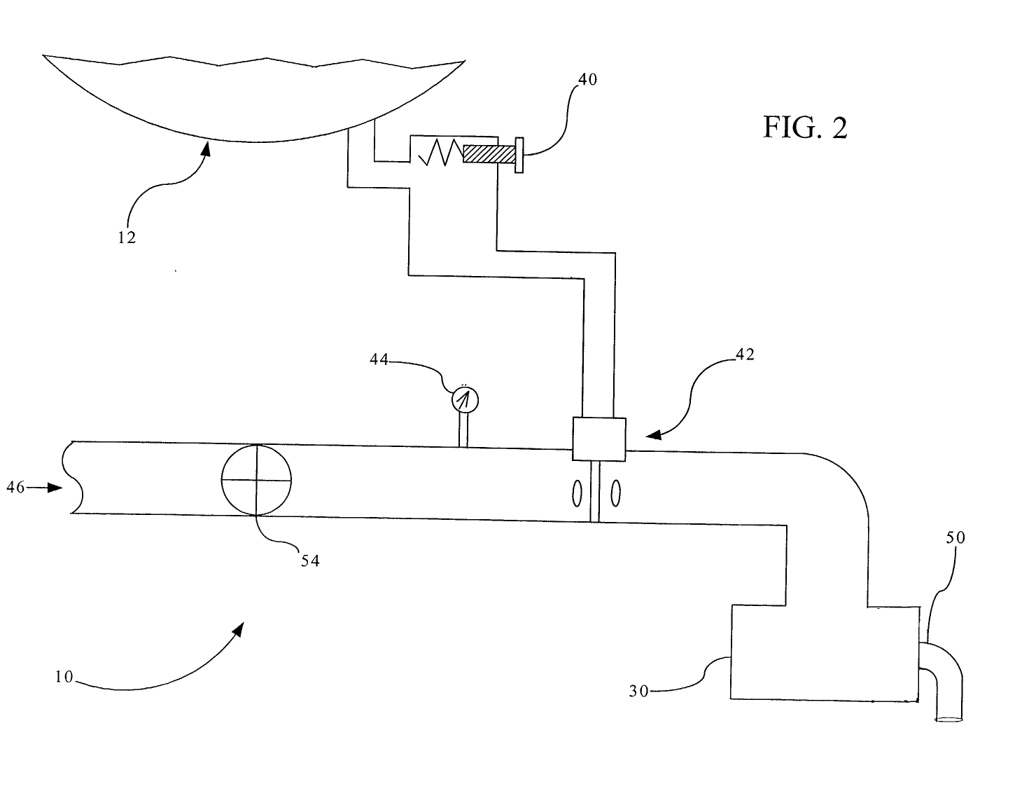

In another embodiment shown in FIG. 2, the system (10) is shown in a configuration that may be used to maintain a selected reduced pressure level. Before the pump down process operation begins, an adjustable vacuum sensor (40) is set for a selected pressure. At the start of the vacuum pump down process, the gate valve (42) on the suction piping (46) of the vacuum pump (30) is open to allow for the free flow of vapors.

When the selected vacuum pressure is achieved, a switch on the adjustable vacuum sensor (40) automatically closes in response to the selected pressure. This closes the gate valve (42) on the pump inlet. The vacuum pump (30) continues to run, pulling vacuum only against the gate valve (42). This permits degassing of condensable vapors from a lubricating oil of the pump (30).

When pressure decreases in the vacuum chamber (12) the adjustable vacuum sensor (40) causes the gate valve (40) to be opened. Pressure can be controlled and adjusted to maintain the selected pressure.

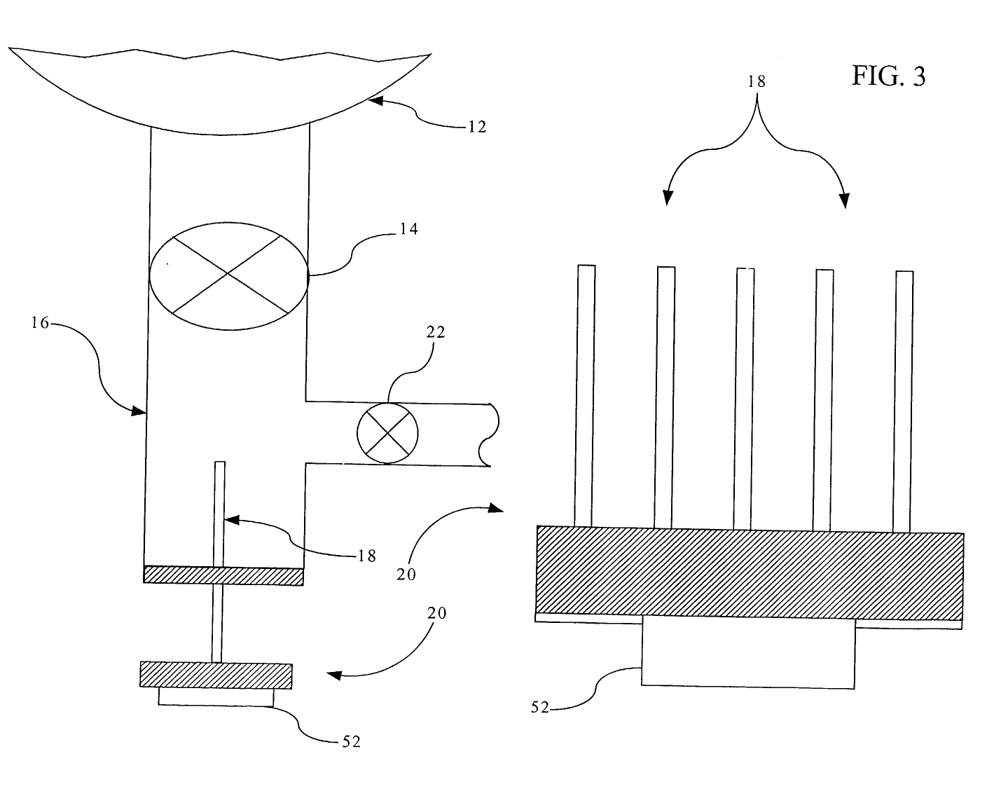

In an alternative embodiment, as illustrated in FIG. 3, the removable threaded cap (20) provides for a multitude of sampling probes (18) in a variety of configurations. The length of the sampling probes (18) can be adjusted so that an increased amount of vaporized particulates comes in contact with the sample media.

The sampling chamber (16) has a removable threaded cap (20) that provides for a plurality of sampling probes (18). During the pressure reduction process, the isolation valve (14) and isolation valve (22) permit isolation of the sampling chamber (16) from the vacuum chamber manifold. Samples can be taken at any time during the process for analysis.

The isolation valve (14) and isolation valve (22) confine a pressure drop to the sampling chamber and prevent a pressure loss in the cargo chamber prior to sampling. The order of closing the isolation valve (14) or isolation valve (22) isolation valves is optional. After closing the isolation valve (14) and isolation valve (22) on the sampling chamber (16), the removable threaded cap (20) is removed and the sampling media is changed. The removable threaded cap (20) is securely closed and the isolation valve (14) and isolation valve (22) are opened. The vacuum chamber effluent again enters the sampling chamber (16) so that additional samples can be obtained. The vacuum process continues with new sampling media on the sampling probe (18).

### EXAMPLES

### Example 1—Detection of Cocaine

This example illustrates detection of cocaine in illegally shipped bulk cargo. The samples tested were obtained as originally seized by United States Customs agents. The cocaine was wrapped in kilogram bricks packaged in packaging film secured with standard tape. The bricks were packed in two 18×18 inch cardboard boxes with a depth of 18 inches weighing 20-30 pounds each. The two boxes were placed inside a 65×12.5 foot diameter cylinder having a total internal volume of about 7,400 cubic feet. A Leybold-Hereaus 100 cfm vacuum pump (Export, Pa.) was used to pump down to a pressure of 445 mm Hg over a period of 15 minutes. The published vapor pressure of cocaine is 1.91×10−7 mm Hg at 25° C. (Handbook of Physical Properties of Organic Chemicals, 1977). The pressure was then maintained at 445 mm Hg using a constant pressure regulator and samples collected from a sampling chamber, illustrated diagrammatically in FIG. 2. The collected vapors were analyzed using an Ion Track mobility Spectrometer (ITMS®, ITEMISER®).

### Example 2—Screening Movable Service Equipment

In addition to providing a method to detect contraband hidden in cargo, the invention provides a method to non-invasively screen large numbers of aircraft passenger cabin equipment and components that are difficult to examine using conventional inspection methods.

For example, smugglers may use aircraft cabin passenger service devices and catering components such as food service carts as vehicles for transporting contraband. The disclosed methods provide means of mass screening by which customs inspectors can segregate equipment, which, under normal operation, is removed from aircraft after each flight segment. Equipment such as food service carts and insulated meal tray carriers may contain contraband hidden within insulated double walls. For example, the average wide-body aircraft carries 15-30 or more food carts that are removed for cleaning and re-stocking after each flight segment. Since there are so many daily flights arriving from numerous high-risk foreign origin points, it is difficult for Customs inspectors to manually examine every arriving food service cart without disrupting operations of the airline catering companies that service the international air carriers. The present invention provides relatively rapid and efficient preliminary screening methods.

As an example, food carts may be removed from an aircraft and individually run through a closed unit on airport premises. After reducing atmospheric pressure in the unit, particulate vapor may be sampled using the systems described herein and illustrated in FIGS. 1, 2 and 3. Carts that are found to produce vapors from cocaine or other illegal drugs can be segregated, torn down and the contraband confirmed using more focused labor-intensive inspection and existing inspection techniques.

### REFERENCES

U.S. Pat. No. 5,200,614

U.S. Pat. No. 6,073,499

The Handbook of Physical Properties of Organic Chemicals, Howard & Meylan, eds. 1977

Lawrence, et al. Can. J. Chem, vol. 62, pp. 1886-1888, 1984

What is claimed is:

1. A method for detecting a selected substance in bulk cargo, comprising
placing bulk cargo in an enclosed environment capable of sustaining a reduced atmospheric pressure;
reducing the pressure within the enclosed environment to a level that causes vaporization of the selected substance;
collecting a vapor sample released from said cargo under the reduced pressure; and
analyzing the vapor sample for the presence of the selected substance.

2. The method of claim 1 wherein the analyzing is by mass spectrometry, gas chromatography, x-ray or liquid chromatography.

3. The method of claim 1 wherein the reduced pressure is less than atmospheric pressure by at least about 500 mm Hg.

4. The method of claim 1 wherein the reduced pressure is between about 500 mm and 1 mmHg.

5. The method of claim 4 wherein the reduced pressure is between about 300 mm Hg and about 20 mm Hg.

6. The method of claim 4 wherein the reduced pressure is about 430 mm Hg.

7. The method of claim 1 wherein the selected substance is selected from the group consisting of a drug, an explosive and a toxin.

8. The method of claim 1 wherein the selected substance is a controlled or illegal drug.

9. The method of claim 1 wherein the selected substance is cocaine.

10. The method of claim 1 wherein the collecting is on polyolefin or ceramic probe.

11. An apparatus comprising:
a closed housing capable of sustaining a reduced atmospheric pressure;
a vacuum system connected to said housing;
a pressure controller for maintaining a constant selected pressure;
a sampling chamber for sampling vapors in the closed housing under the reduced atmospheric pressure; and
an analysis device connected to the sampling chamber.

12. The apparatus of claim 11 further comprising a plurality of probes that specifically detect a selected substance.

13. The apparatus of claim 12 wherein the plurality of probes each specifically detects a different selected substance.

14. The apparatus of claim 11 further comprising a thermocouple probe comprised within the closed housing.

15. The apparatus of claim 14 further comprising a temperature control.

16. A system comprising the apparatus of claim 11.

17. The system of claim 16 further comprising at least one sampling probe positioned within the sampling chamber wherein said probe provides material to an automatic analyzer.

18. The system of claim 16 comprising a plurality of sampling probes wherein each probe is sensitive to a selected different substance and wherein each probe provides material to an analyzer that differentially detects each selected different substance.

19. The system of claim 18 wherein the material from each probe is analyzed by a different analytical method.
